(19) United States
(12) Patent Application Publication
(10) Pub. No.: US 2020/0002597 A1
(43) Pub. Date: Jan. 2, 2020

(54) PROCESS TO PREPARE A SOLID CEMENT COMPOSITION

(71) Applicant: SHELL OIL COMPANY, HOUSTON, TX (US)

(72) Inventors: Guy Lode Magda Maria VERBIST, Amsterdam (NL); Gerbrand Jozef Maria VAN EIJDEN, Rijswijk (NL); Cornelis Pieter HAMELINK, Amsterdam (NL)

(21) Appl. No.: 16/348,546

(22) PCT Filed: Nov. 10, 2017
(86) PCT No.: PCT/EP2017/078894

§ 371 Date: May 9, 2019

(30) Foreign Application Priority Data
Nov. 11, 2016 (EP) 16198493.5

(51) Int. Cl. C09K 8/493; C04B 28/04; C04B 24/36; C04B 40/00; E21B 33/14

(52) U.S. Cl. CPC C09K 8/493; C04B 28/04; E21B 33/14; C04B 40/0085; C04B 24/36

(57) ABSTRACT

A process to prepare a solid cement composition;
includes adding a meltable compound to an aqueous slurry of cement and;
mixing until a homogeneous dispersion is obtained.
The dispersion is placed in a mould, where the dispersion is set by hydration. Part
of the meltable compound is melted at a temperature range of which the maximum is above the melting point of the meltable compound and a minimum below the melting point of the meltable compound.
A material, either still as a dispersion or an already setting cement is exposed to heat development or a temperature gradient such that the temperature is at least above the congealing point of the meltable compound to obtain a solid cement composition.

### FIELD OF THE INVENTION

The present invention relates to a process to prepare solid cement composition and said solid cement composition. The present invention also relates to the use of the solid cement composition for sealing a wellbore and/or for sealing within a wellbore.

### BACKGROUND OF THE INVENTION

The main objectives for drilling a well are to create a connection to the oil and/or gas reservoir and to install tubing between the reservoir and the surface. The outer steel protection is called the casing. The casing requires a gas tight seal between the reservoir and the surface. To achieve such seal, the annulus (the gap between the casing and the rock/formation) is subjected to a cementing (or grouting) operation. This treatment is normally referred to as Primary Cementing. The main aspects of primary cementing are to isolate flow between different reservoirs, to withstand the external and internal pressures acting upon the well by offering structural reinforcement and to prevent corrosion of the steel casing by chemically aggressive reservoir fluids.

A poor cementing job can result in migration of reservoir fluids, even leading to gas migration through micro-annuli in the well which not only reduces the cost effectiveness of the well but may cause a “blow out” resulting in considerable damage. Although repair jobs (“secondary cementing”) are possible (in essence forcing more cement into the cracks and micro-annuli) are possible they are costly and do not always lead to the desired results.

When a well has reached the end of its economically productive life, the well needs to be abandoned in compliance with local regulations. Abandonment is usually carried out by first plugging each of the casings in a large number of sequential steps, cutting and removing the steel casings and placing a large cement plug to seal the well. As only a relatively small volume of cement (typically in the order of 100 m) is used to place the plug, its quality needs to be sufficient as it will serve as a seal for a very long time.

The customary abandonment operation is very costly, especially in an off-shore environment, since it requires the use of a workover or drilling rig. It would be very beneficial if methods were available which could lead to abandonment of wells without the necessity to remove the production tubing.

One of the major drawbacks of using traditional cementing materials such as Class G Cement (e.g. OPC: Ordinary Portland Cement) in plugging is that such materials cannot achieve a gas tight seal due to the inherent shrinkage of the materials. Shrinkage is typically in the order of 4-6% by volume which causes gas migration through the micro-annuli created because of the shrinkage. The use of such cementing material in “remedial secondary cementing” has the disadvantage that the customary grain size is too large to pass freely into the micro-annuli which affects the quality of the seal. When servicing a wellbore in a cold environment such as permafrost or in the presence of gas hydrates, the heat released by the exothermic hydration of cement may present a problem which can be mediated by absorbing heat in additives undergoing a phase transition. In that respect, US2010/0116170 relates to a method of servicing a wellbore comprising placing a composition comprising cement, water, and a heat sink material into a wellbore, and allowing the composition to set, wherein at least a portion of the heat sink material undergoes a phase transition by absorbing at least a portion of the heat released upon hydration of the cement. A disadvantage of the use of the heat sink material is the phase transition of the heat sink material is dependent on hydration of the cement. The heat generated by hydrating cement will generally lead to a temperature increase lower than 50° C.

US2011/0290493 relates to compositions and methods for completing subterranean wells, in particular fluid compositions and methods for completion operations during which the fluids compositions are pumped into a wellbore and make contact with subterranean rock formations. The composition for providing fluid-loss control in a subterranean well comprises a process fluid and a particulate additive. The additive is characterized in that the glass-transition temperature of the particulate is lower than the bottom-hole temperature and the particle size of the additive is smaller than 1 micrometer. US2011/0290493 only relates to the use of amorphous material, which is characterized by its glass transition temperature. The glass transition temperature is known by the skilled person in the art and is for example described in “Advances in Food and Nutrition Research, Volume 48, page 68, Edited by Steve L Taylor, Elsevier 2004, ISBN: 0-12-016448-5. At this temperature a reversible change in an amorphous material or in amorphous regions of a partially crystalline material take place, from (or to) a viscous or rubbery condition to (or from) a hard and relatively brittle one. The present invention proposes highly crystalline material, such as FT wax, which undergo a real phase transition, the solid/liquid phase transition, that is characterized by a melting point temperature.

In the search for effective cementing materials, attention has to be paid to inter alia the following requirements: the material should be gas-tight (i.e. withstand at least 2 bar per m), it should have a controllable setting time so that a range of temperatures and well depths (each requiring different conditions) can be coped with, it should be thermally stable up to 250° C. as well as being chemically stable against reservoir fluids for a very long period of time and its rheological properties should be such that pumping through existing oil field equipment can be carried out without too much problems.

A wide range of non cementious plugging agents has been suggested to cope with at least part of the problems outlined hereinabove. Examples of such materials are Epoxy Resins (R. Ng and C. H. Phelps: “Phenolic/Epoxy Resins for water/Gas Profile Modification and Casing Leak Repair”—Paper ADSPE # 90, presented at the ADIPEC, held in Abu Dhabi (16-19) October 1994), Phenol- or Melamine Formaldehyde (W. V. C. de Landro and D. Attong: “Case History: Water Shut-off using Plastic Resin in a High Rate Gravel pack Well”—Paper SPE 36125 presented at the 4th Latin American and Caribbean Petroleum Engineering Conference, held at Port of Spain in Trinidad, 2326 April 1996) and Poly-acrylates (U.S. Pat. No. specification 5,484,020 assigned to Shell Oil).

Also rubbers have been proposed in general for use as plugging materials. Reference is made to U.S. Pat. No. specification 5,293,938 (assigned to Halliburton Company) directed to the use of compositions consisting essentially of a mixture of a slurry of a hydraulic cement (such as Portland cement) and a vulcanisable rubber latex. Rubbers specifically referred to in said US patent specification are natural rubbers, cispolyisoprene rubber, nitrile-rubber, ethylene-propylene rubber, styrene butadiene rubber, butyl rubber and neoprene rubber. The use of silicone rubber is also stated as a possibility but such rubber generally has less desirable physical properties, requiring incorporation of inorganic extenders.

The vulcanisation of the rubber involves the crosslinking of the polymer chains which can be accomplished by incorporating one or more crosslinking agents (the most common one being sulphur) in the rubber latex (latex having been defined as the aqueous dispersion or emulsion of the rubber concerned).

Although above described materials can be instrumental in solving some of the problems encountered with traditional, cement-based plugs, there are still important drawbacks to be reckoned with in terms of handling aspects, control of setting times and long term durability.

It is an object of the invention to provide a simple process to prepare a solid cement composition with extremely reduced porosity and permeability.

It is a further object to provide a solid cement composition with extremely reduced porosity and permeability.

Another object of the present invention is to provide a simple and controlled process for sealing a wellbore and/or for sealing within a wellbore.

### SUMMARY OF THE INVENTION

From a first aspect, above and other objects may be achieved according to the present invention by providing a process to prepare solid cement composition, comprising the steps of:
(a) addition of a meltable compound to an aqueous slurry of cement;
(b) mixing of the meltable compound in the form of solid particles and the aqueous slurry of cement of step (a) until a homogeneous dispersion of cement comprising dispersed meltable compound is obtained;
(c) placing a dispersion of (b) in a mould, wherein the dispersion is set by hydration;
(d) melting part of the meltable compound by exposing the meltable compound to a temperature range of which the maximum is above the melting point of the meltable compound and a minimum below the melting point of the meltable compound;
(e) exposing a material, either still as a dispersion or an already setting cement of step (c), to heat development or temperature gradient such that the temperature is at least above the congealing point of the meltable compound to obtain a solid cement composition.

It has been found that the process according to the present invention uses a meltable compound to prepare a solid cement composition, which meltable compound seal the inherent porosity of the cement; i.e., the meltable compound will only start to seal when temporarily applied at a temperature above its congealing point.

From a second aspect, the invention embraces a solid cement composition. An advantage of the present invention is, is that due to the use of the meltable material a solid cement composition with extremely reduced porosity and permeability is provided.

From a third aspect, the invention resides in use of said solid cement composition for sealing a wellbore and/or for sealing within a wellbore.

The advantage of said use is that the meltable compound for preparing a solid cement composition provides for a gas tight seal between the reservoir and the surface. In addition, the meltable compound can be chosen such that a range of temperatures and well depths (each requiring different conditions) can be coped with. In this way the present invention may be used for well abandonment and zonal isolation.

### DETAILED DESCRIPTION OF THE INVENTION

In step (a) according to the process of the present invention, a meltable compound is added to an aqueous slurry of cement. Preferably, the addition occurs at room temperature. Typically cements to be used in the aqueous slurry of cement according to the present invention is traditional cementing materials such as Class H and class G Cement (e.g. OPC: Ordinary Portland Cement). Other cements which have comparable properties with the Portland cements mentioned can also be used. The amount of cement in the aqueous cement slurry is typically between 0.30 and 0.60 wt. %, preferably between 0.40 and 0.50 wt. %, more preferably 0.44 wt. % based on the total amount of water and cement in the aqueous cement slurry. Typically, the aqueous cement slurry comprises a number of additives that enhance the sealing of the cement in the wellbores. These additives are known in the art and therefore not discussed in detail. Oil well cements and various additives for different purposes are for example described in “Halliburton Company, Halliburton Cementing Tables, Technical Data Oil Well Cements and Cement Additives” (Duncan, Okla.: Halliburton, 1981).

Preferably, the amount of meltable compound added in step (a) to the aqueous slurry of cement is between 1 and 50 wt. %, preferably between 10 and 20 wt. % based on the amount of cement.

By the term “meltable compound” is meant a compound of which at least a part melts when exposed to a temperature range of which the maximum is above the melting point of the meltable compound and a minimum below the melting point of the meltable compound.

In the specific case of a wellbore, the maximum temperature would be at the bottom of the wellbore and the minimum temperature at the surface.

The meltable compound is preferably presented as the solid particles with a particle size of between 0.1 and 0.5 mm, more preferably between 0.1 and 0.3 mm. Optionally meltable compounds are wax, encapsulated minerals, and rubbers. The meltable compound is preferably a wax.

The wax preferably has a congealing point of at least 30° C. and at most 120° C. Suitably, the wax has a congealing point of at most 115° C., preferably at most 110° C. Also, the wax has preferably a congealing point of 105° C. In addition, the wax is preferably presented as the solid particles with a particle size of between 0.1 and 0.5 mm, more preferably between 0.1 and 0.3 mm.

Suitably, wax used as meltable compound in step (a) is a natural wax, such as beeswax, a petroleum derived wax or a synthetic derived wax. Suitable natural waxes are for example disclosed in the “International Journal for Applied Science, 4-2011, Natural waxes-Properties, Compositions and Applications, E. Endlein, K Peleikis; Natural Waxes-Properties, Compositions and Applications”.

Preferably, wax used as meltable compound in step (a) is a paraffin wax. Paraffin wax may be obtained by various processes. U.S. Pat. No. 2,692,835 discloses a method for deriving paraffin wax from crude oil. Also, paraffin wax may be obtained using the so called Fischer-Tropsch process. Suitably, the Fischer-Tropsch derived paraffin wax is preferably presented as the solid particles with a particle size of between 0.1 and 0.5 mm, more preferably between 0.1 and 0.3 mm. An example of such process is disclosed in WO 2002/102941, EP 1 498 469, and WO 2004/009739. In addition, the wax is preferably a Fischer-Tropsch derived wax.

In step (b) according to the process of the present invention the meltable compound and the aqueous slurry of cement of step (a) is mixed until a homogeneous dispersion of cement comprising dispersed meltable compound is obtained. By the part “homogeneous dispersion of cement comprising dispersed meltable compound” is meant the aqueous slurry of cement as liquid continuous medium with the solid meltable compound dispersed in the liquid continuous medium. Typically, the meltable compound is micronized in such a way that the meltable compound does not separate from the liquid continuous medium of cement.

In step (c) according to the present invention the dispersion of (b) is placed in a mould, wherein the dispersion is set by hydration. Suitably, the dispersion of step (b) is placed in a mould by pouring the dispersion at room temperature in a mould, casing or tube. Moulds, such as casing, casing of a wellbore, tube are known in the art and therefore not discussed here

Hydration of the dispersion leads to setting of the cement. Setting of cement refers to changes of aqueous cement slurry from a liquid to rigid state.

Setting time of cements are known in the art and therefore not discussed here. Setting time is for example affected by minor constituents in the cement such as alkalis and Sulfates, by fineness, water-cement ratio, ambient temperature and inclusion of mineral and chemical admixtures.

Preferably, at least 80% of the dispersion is set by hydration, more preferably at least 90% of the dispersion is set by hydration.

In step (d) according to the present invention a material, either still as a dispersion or an already setting cement of step (c), is exposed to heat development or a temperature gradient such that the temperature is at least above the congealing point of the meltable compound to obtain a solid cement composition.

Preferably, the heat development, to which the dispersion or setting cement is exposed to, is caused by the hydration of cement, which hydration reaction generate heat. Also, the temperature gradient, to which the dispersion or setting cement is exposed to, is the vertical temperature gradient of the wellbore area occupied by the cement.

An advantage of the use of a meltable compound to prepare a solid cement is that the meltable compound, when exposed to a temperature above its congealing point will seal the inherent porosity of cement and heal cracks that occur from cement setting and shrinkage and thus for a solid cement composition with extremely reduced porosity and permeability.

In a further aspect, the present invention provides a solid cement composition.

Preferably, the meltable compound in the solid cement composition according to the present invention is a Fischer-Tropsch derived wax. In addition, the Fischer-Tropsch derived wax has a congealing point of at least 30° C. and at most 120° C. Also, the amount of Fischer-Tropsch derived wax in the solid cement composition is in a range between 1 to 50 wt. %, preferably 20 to 35 wt. % based on the amount of the solid cement composition.

The inherent porosity of cement and cracks that occur from cement setting and shrinkage and those effect on wellbores is known in the art and is for example described in Celia, M. A., S. Bachu, J. M. Nordbotten, S. Gasda, H. K. Dahle, 2004. Quantitative estimation of CO2 leakage from geological storage: Analytical models, numerical models, and data needs, In, E. S. Rubin, D. W. Keith and C. F. Gilboy (Eds.), Proceedings of 7th International Conference on Greenhouse Gas Control Technologies. Volume 1: Peer-Reviewed Papers and Plenary Presentations, IEA Greenhouse Gas Programme, Cheltenham, UK.

In another aspect, the present invention provides the use of the solid cement composition according to the present invention, for sealing a wellbore and/or for sealing within a wellbore, comprising the steps of
(a) addition of a meltable compound to an aqueous slurry of cement;
(b) mixing of the meltable compound in the form of solid particles and the aqueous slurry of cement of step (a) until a homogeneous dispersion of cement comprising the dispersed meltable compound is obtained;
(c) addition of the homogeneous dispersion of step (b) to a wellbore, wherein the dispersion is set by hydration;
(d) melting part of the meltable compound by exposing the meltable compound to a temperature gradient with its maximum (bottom hole temperature) above the melting point of the meltable compound and its minimum (surface temperature) below the melting point of the meltable compound;

It may be noticed that the local temperature may be increased by the exothermic setting of the cement due to the hydrolysis reaction.

With bottom hole temperature is meant the temperature at the lowest point of the well and with surface temperature, the temperature at the highest point of the well.

Preferably, for the above use a Fischer-Tropsch derived wax as meltable compound is used for sealing a wellbore and/or for sealing within a wellbore. More preferably, a Fischer-Tropsch wax having a congealing point of 105° C. is used.

The advantage of using a meltable compound in the preparation of the solid cement composition according to the present invention is that the meltable compound will seal, when above its congealing point, a wellbore by sealing the cement pore space of a cement well plug or within a wellbore by sealing the space between the plug and casing.

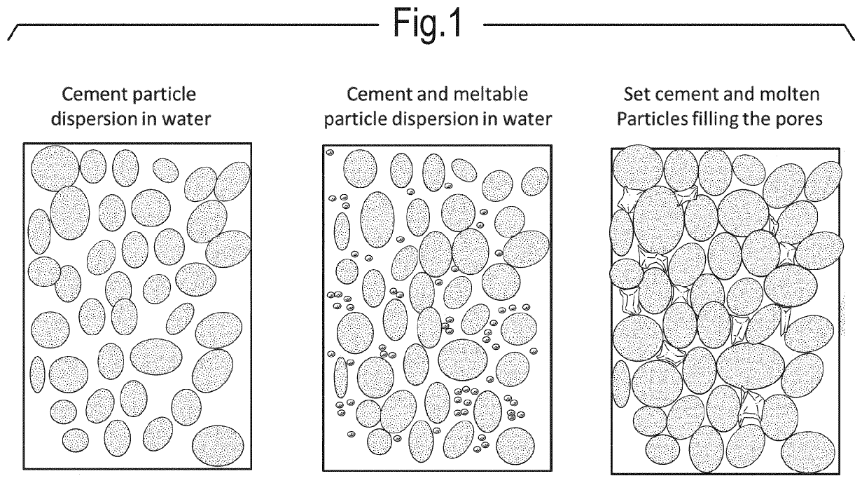

FIG. 1 shows the effect of the meltable compound on porosity and permeability of cement. Preferably, the material of step (d) is exposed to the temperature gradient of the wellbore or to heat development caused by the hydration reaction of cement.

Also, the temperature of the well is preferably increased prior to placing the homogeneous dispersion of step (b) in the well in step (c).

In an another embodiment of the present invention, step (c) and (d) of the process for sealing a wellbore and/or with a wellbore according to the present invention are taking place simultaneously.

The use of the solid cement composition according to the present invention for sealing a wellbore and/or within a wellbore is preferably used for well abandonment and/or zonal isolation.

The process for using cement composition for well abandonment and/or zonal isolation is a known process and is for example described in U.S. Pat. No. 6,196,316.

The present invention is described below with reference to the following Examples, which are not intended to limit the scope of the present invention in any way.

### Experimental

### Comparative Example

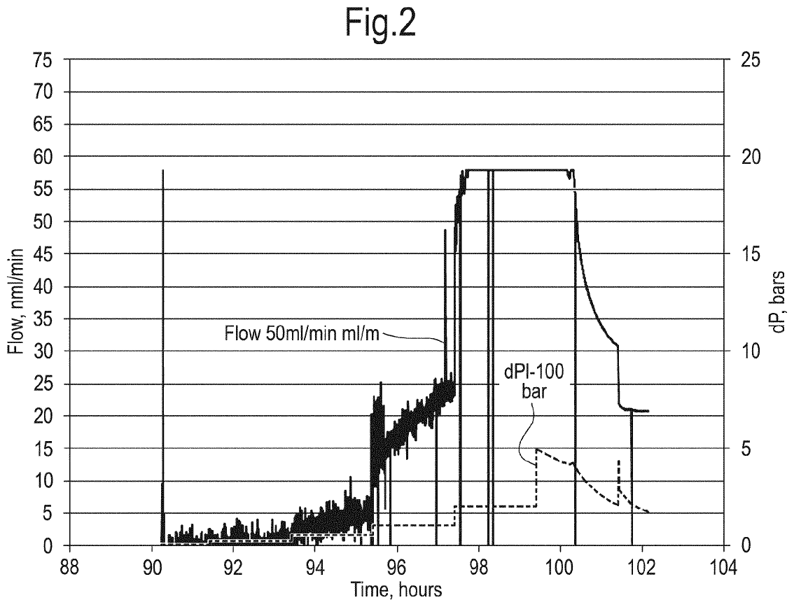

An aqueous cement slurry was prepared with normal Portland class-g cement (commercially available from Dyckerhoff). The water to cement ratio in this aqueous cement slurry is 0.44 wt. %. This slurry was introduced into a steel tube. After closure of the tube the temperature of the cement cylinder was raised to 80° C. and the pressure was increased to 80 bar. The cement slurry was allowed to set at the given pressure and temperature conditions for 96 hours to form a plug inside the steel tube. After 96 hours the pressure was stepwise lowered at one end, creating a pressure drop over the cement cylinder to measure the hydraulic sealing performance of the cement plug. FIG. 2 shows the flow of nitrogen measured through the cylinder.

### Example

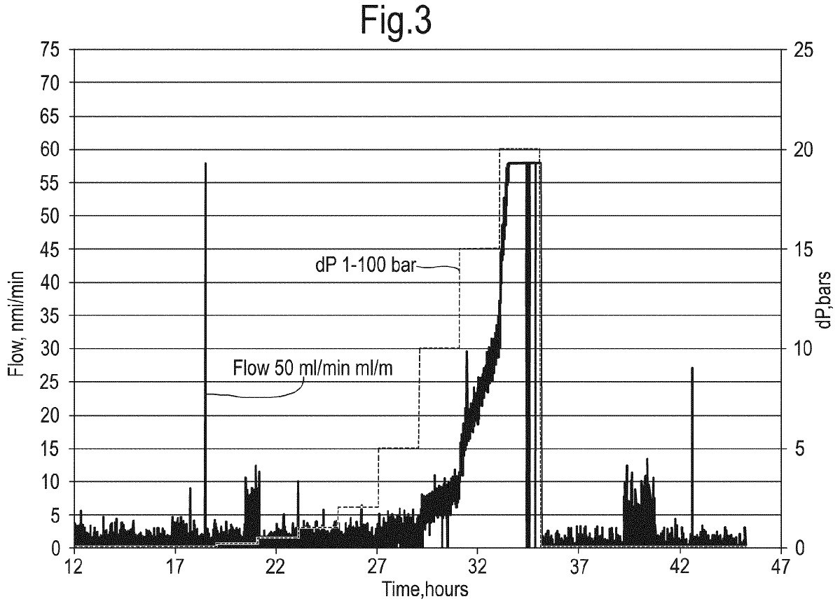

An aqueous cement slurry was prepared with normal Portland class-g cement (commercially available from Dyckerhoff). The water to cement ratio in this aqueous cement slurry was 0.44 wt. %. To this aqueous cement slurry micronized Fischer-Tropsch derived wax particles with a congealing point of 105° C. (SX105, commercially obtained from Evonik) was added. The amount of wax added to the slurry was 10 wt. % based on the amount of cement used for preparing the slurry. This slurry was blended to obtain a homogeneous dispersion of cement comprising dispersed SX105 particles in the cement slurry. The obtained homogeneous slurry was introduced into a steeltube. After closure of the tube the temperature of the cement cylinder was raised to 120° C. and the pressure was increased to 120 bar. After 30 hours the pressure was lowered at one end, creating a pressure drop over the cement cylinder. FIG. 3 shows the flow of nitrogen measured through the cylinder.

### Discussion

The results from FIGS. 2 and 3 show that upon using a homogenous cement dispersion comprising a Fischer-Tropsch derived wax only shows a leakage in the cement at a pressure drop of 5 bar whereas the untreated cement plug (see comparative example) already show leakage behaviour at a pressure drop of 0.5 bar.

These observations indicate that by using meltable wax particles, those meltable wax particles may seal the inherent porosity of cement and heal cracks that occur from cement setting and shrinkage.

In this way, the present invention may be used for well abandonment and zonal isolation.

1. A process to prepare a solid cement composition, comprising the steps of:
(a) adding a meltable compound to an aqueous slurry of cement;
(b) mixing the meltable compound in the form of solid particles and the aqueous slurry of cement of step (a) until a homogeneous dispersion of cement comprising dispersed meltable compound is obtained;
(c) placing a dispersion of step (b) in a mould, wherein the dispersion is set by hydration;
(d) melting part of the meltable compound by exposing the meltable compound to a temperature range of which the maximum is above the melting point of the meltable compound and a minimum below the melting point of the meltable compound;
(e) exposing a material, either still as a dispersion or an already setting cement of step (c), to heat development or temperature gradient such that the temperature is at least above the congealing point of the meltable compound to obtain a solid cement composition.

2. The process according to claim 1, wherein the amount of meltable compound added in step (a) to the aqueous slurry of cement is between 1 and 50 wt. % based on the amount of cement.

3. The process according to claim 1, wherein the meltable compound is a wax.

4. The process according to claim 3, wherein the wax has a congealing point of at least 30° C. and at most 120° C.

5. The process according to claim 3, wherein the wax has a congealing point of 105° C.

6. The process according to claim 3, wherein the wax is a Fischer-Tropsch derived wax.

7. A solid cement composition obtainable by the process according to claim 1.

8. A process for sealing a wellbore and/or for sealing within a wellbore, comprising the steps of
(a) adding a meltable compound to an aqueous slurry of cement;
(b) mixing the meltable compound in the form of solid particles and the aqueous slurry of cement of step (a) until a homogeneous dispersion of cement comprising the dispersed meltable compound is obtained;
(c) addition of the homogeneous dispersion of step (b) to a wellbore, wherein the dispersion is set by hydration;
(d) melting part of the meltable compound by exposing the meltable compound to a temperature gradient with its maximum (bottom hole temperature) above the melting point of the meltable compound and its minimum (surface temperature) below the melting point of the meltable compound;

9. The method according to claim 8, wherein the material of step (d) is exposed to the temperature gradient of the wellbore or to heat development caused by the hydration reaction of cement.

10. The method according to claim 8, wherein sealing is used for well abandonment and/or zonal isolation.

11. The method according to claim 9, wherein sealing is used for well abandonment and/or zonal isolation.
